(19) United States
(12) Patent Application Publication
(10) Pub. No.: US 2026/0097919 A1
(43) Pub. Date: Apr. 9, 2026

(54) DEVICE AND METHOD FOR CONNECTING MATERIAL WEBS FOR THE PRODUCTION OF ENERGY CELLS

(71) Applicant: KÖRBER TECHNOLOGIES GMBH, HAMBURG (DE)

(72) Inventors: Matthias HORN, AHRENSBURG (DE); Karl Richard BUSCH, HAMBURG (DE); Axel HENNING, OSTSTEINBEK (DE); Frank GROTHAUS, PAPENBURG (DE)

(21) Appl. No.: 19/116,177

(22) PCT Filed: Sep. 19, 2023
(86) PCT No.: PCT/EP2023/075798

§ 371 Date: Mar. 27, 2025

(30) Foreign Application Priority Data
Oct. 4, 2022 (DE) 10 2022 125 535.2

(51) Int. Cl. B65H 19/18; B65H 19/10; B65H 19/20; H01M 10/04

(52) U.S. Cl. CPC B65H 19/1836; B65H 19/102; B65H 19/20; H01M 10/0404; B65H 2301/46312; B65H 2801/72

(57) ABSTRACT

The invention relates to a device and a method for joining webs of material for the production of energy cells, wherein a running-out web of material can be joined to a new web of material. The running-out web of material and the new web of material are guidable at a distance from each other in a joining section, wherein two pivotable or rotatable pressure elements are provided with pressure surfaces which are adapted to press the running-out and the new web of material against each other in the joining section and to join the running-out web of material and the new web of material to each other. The pressure elements are adapted to join the webs of material during the movement in the conveying direction of the running-out and the new web of material. The device is adapted to produce a weakened line in the running-out and in the new webs of material and to separate the webs of material in each case by applying increased tensile stress in the webs of material at the weakened lines, preferably the perforation lines.

The present invention relates to a device for joining webs of material, in particular separator foils, for the production of energy cells according to the preamble of claim 1, as well as a corresponding method according to the preamble of claim 14.

Energy cells or energy storage devices in the sense of the invention are used, for example, in motor vehicles, other land vehicles, ships, aircraft or also in stationary systems, such as in the form of battery cells or fuel cells, in which very large amounts of energy have to be stored over long periods of time. For this purpose, such energy cells comprise a structure of layered materials, which usually consist of an anode material on a conductor foil and a cathode material on a conductor foil and a separator foil, wherein the separator foil is arranged between the anode material and the cathode material. Such a material composite can be present in an energy cell in a stacked, rolled or folded arrangement.

To achieve a high production speed, the materials for the anode, cathode and separator are processed as webs of material as far as possible. These webs of material, which may be semi-finished or also intermediate products, are usually supplied as a bobbin or coil or transported between different systems in this form. Bobbins inevitably comprise a limited length of web. To maximize the production rate and thus minimize production costs, it is advantageous to have a continuous production process with a high speed and an endless web, so that each running-out web of material is joined to new webs of material. To ensure continuous production, process storages or buffer storages are known, which represent a buffer so that the connection of two webs of material can be produced to achieve an endless web, while the further production process is carried out with the web of material from the buffer storage. However, increasing production speeds in the manufacture of energy cells, for example Li-ion batteries, cannot be compensated for by ever larger buffer storages, so that the joining process should be carried out as dynamically as possible during conveying, for example at production speed, in order to be able to design the buffer storage as small as possible or to do without a buffer storage completely. Doing without buffer storage reduces the space required for a plant and also offers potential for cost advantages.

The object of the invention is therefore to provide a device and a method that enable an as fast and efficient connection of webs of material as possible.

The object is solved by the features of the independent claims. Further preferred embodiments of the invention are set forth in the dependent claims, figures and description relating thereto.

A device for joining webs of material, in particular separator foils, for the production of energy cells is proposed, wherein a running-out web of material can be joined to a new web of material. The running-out web of material and the new web of material are guidable at a distance from each other in a joining section, preferably one above the other at a distance from each other. Two pivotable or rotatable pressure elements with pressure surfaces are provided, which are adopted to press the running-out and the new web of material against each other in the joining section and to join the running-out web of material and the new web of material to each other. The pressure elements are adapted to join the webs of material during the movement in the conveying direction of the running-out and the new web of material, and the device is adapted to produce a weakened line, preferably a perforated line, in the running-out and new web of material and to separate the webs of material in each case by applying an increased tensile stress in the webs of material at the weakened lines, preferably the perforated lines.

The webs of material comprise a distance to each other before being joined. The new and the running-out webs of material are preferably guided in parallel. Furthermore, the respective edges of the new and the running-out webs of material preferably lie in a plane perpendicular to a plane of the surface of at least one of the webs of material in the joining section. Furthermore, the webs of material preferably lie with their planes or their base surfaces on top of each other, wherein the webs of material are guided at a distance from each other. In this context, “on top of each other” refers to the alignment of the webs of material in relation to each other in a joining section of the device. In the joining section, the webs of material are guided before, during and/or after joining. In the joining section, the webs of material are preferably guided over two rollers each.

The device is preferably adapted to convey the new and the running-out webs of material at the same conveying speed, at least immediately before and/or during the joining of the webs of material by pressing them against each other by means of the pressure elements, so that there is no relative speed of the webs of material to the process speed for the subsequent processes during the joining process. The connection is made in an overlap area of the two webs of material, on which the pressure elements act, so that a splice with overlap is formed. The pressure elements preferably displace the new and the running-out web of material towards each other, so that the distance between the webs of material is eliminated and the webs of material are pressed onto each other or against each other. When displacing the course of at least one web of material and when pressing both webs of material, the rotatable pressure elements preferably also comprise a speed that is adapted to and synchronized with the speed of the new and running-out web of material. This makes it possible to produce a dynamic connection or a dynamic splice between the new web of material and the running-out web of material with an overlap during the ongoing conveying.

The pressure elements preferably have the process speed or conveying speed of the webs of material, in particular of the running-out web of material on the side in the conveying direction, at the moment of pressing against each other or joining. There is preferably no slippage between the pressure surfaces and the webs of material. The pressure elements are preferably arranged on both sides of the webs of material in the joining section.

The device is preferably adapted to produce the weakened lines in the webs of material at a time before the webs of material are pressed against each other to be joined. Furthermore, the device can preferably be adapted to produce the weakened line during the pressing of the webs of material against each other, in particular by the pressure elements themselves.

The weakened line in the running-out web of material is behind the joint or the later joint of the webs of material, upstream the conveying direction, and the weakened line in the new web of material is in front of the joint or the later joint of the webs of material, downstream the conveying direction.

The proposed device is particularly suitable for separator webs or separator foils of an energy cell, in particular a battery cell, since the separator foils are comparatively thin and the absolute increase in the overlap area of the joint is small compared to coated electrode webs, for example.

According to a further development, it is proposed that the pressure surfaces of the pressure elements are embossing surfaces and the pressure elements are adapted to produce an embossed joint when the running-out and new webs of material are pressed against each other.

The embossed joint enables the webs of material to be joined without further joining elements and without temperature changes. An embossed joint is particularly suitable for separator foils of an energy cell, in particular of a battery cell, since the separator foils are generally homogeneous webs of material compared to coated electrode webs. The embossing surfaces of the pressure elements comprise a suitable surface design for this purpose; in particular, the embossing surfaces of the pressure elements preferably comprise embossing surfaces that correspond to one another. In possible embodiments, the pressure elements can also be referred to as embossing elements.

In advantageous embodiments, the pressure elements, for example with the embossing surfaces, are adapted to produce a weakened line in each of the new and running-out webs of material.

In possible embodiments, a weakened line can also be present at the transition from an embossed joining portion to an unembossed portion of a web of material.

In an alternative embodiment, it is proposed that the device comprises an adhesive sheet holder that is adapted to hold a double-sided adhesive sheet between the running-out and the new web of material, wherein the pressure elements are adapted to produce an adhesive bond between the webs of material together with the adhesive sheet when the running-out and the new web of material are pressed against each other.

This can also be used to produce a dynamic joint or a dynamic splice between the new web of material and the running-out web of material. The adhesive joint can be produced with a high degree of bonding strength by the pressure elements, which first displace the two webs of material towards the adhesive sheet and then press the webs of material onto the adhesive sheet from both sides.

In possible further embodiments, a sealing joint of the webs of material can also be produced by a combination of an adhesive bond and an embossed bond using the proposed device.

It is further proposed that the device is adapted to increase the tensile stress in the new web of material and/or in the running-out web of material during the production of the embossed joint and/or the adhesive joint in order to separate each of the webs of material by means of the increased tensile stress.

This enables targeted separation at the weakened line or perforation line, which can also be achieved in terms of timing in the running-out process by controlling the tensile stress when the webs of material are pressed against each other. The temporary increase in tensile stress causes the respective web of material to tear at the weakened line. The tearing of the material web preferably occurs while pressing against each other, which relatively fixes the material web at the current conveying speed so that a particularly targeted build-up of tensile stress can occur in a section with the weakened line. In the conveying direction downstream the junction, for example, the conveying speed of the new web of material can be increased to increase the tensile stress. Upstream the conveying direction of the junction, for example, the conveying speed of the running-out web of material can be reduced to increase the tensile stress.

According to a further development, it is proposed that the device is adapted to build up increased tensile stress in the running-out web of material between the weakened line and a bobbin with the running-out web of material in order to separate the running-out web of material, and to build up increased tensile stress in the new web of material between the weakened line and a leader winder with the new web of material in order to separate the new web of material.

The bobbin with the running-out web of material can, for example, run at a lower peripheral speed than the process speed at the moment of pressing or joining against each other by the pressure elements, whereby the remaining part of the running-out web of material or also the trailing end is cut off. The leader winder can be operated at a speed higher than the process speed or than the speed of the running-out web of material in the direction of conveyance of the joint at the moment of pressing against each other or joining, in order to achieve a corresponding increase in the tensile stress and a separation at the weakened line.

It is further proposed that the pressure elements each comprise a curved, in particular single-curved, preferably circular arc-shaped pressure and/or embossing surface, which runs on one of the webs of material during pressing and/or embossing.

This allows for a slip-free contact between the pressure element and the web of material with a uniform movement, whereby the open-loop or closed-loop control of the movement of the pressure element is simplified and undesired tension peaks in the webs of material can be avoided.

According to a further development, it is proposed that, in opposition to a conveying direction, in front of the joining section for the running-out web of material and/or the new web of material, a weakening device, preferably a weakening device in each case, is provided, which is adapted to produce a weakened line in a web of material.

The weakening device is preferably arranged between a bobbin of the running-out web of material and a bobbin of the new web of material and the joining section.

The weakening device produces a weakened line, for example a perforated and/or a partially cut line and/or a crushed line in one or both webs of material. The generation of the weakened line in the new web of material is preferably synchronized by the weakening device with the movement of the pressure elements in time in such a way that the weakened line of the new web of material lies behind the pressure elements due to the continuous conveying while the webs of material are pressed against each other, so that the leader of the new web of material can be separated. In the case of the running-out web of material, the generation of the weakened line is preferably synchronized by the weakening device with the movement of the pressure elements in time in such a way that the weakened line of the running-out web of material lies in front of the pressure elements due to the continuous conveying when the material webs are pressed against each other, so that the remaining part of the running-out web of material can be separated.

It is further proposed that the weakening device comprises a knife roller and a counter roller, wherein the counter roller is pivotable and adapted to come into contact with a web of material when pivoted, to displace the web of material and to press it against a knife roller.

This makes it possible to generate the weakened line as a predetermined breaking point in the webs of material while the web of material is moving at the conveying speed. The counter roller displaces the course of the web of material towards the knife roller, wherein the counter roller rolls preferably passively on the web of material. The counter roller serves as a counterholder for the knife roller, which preferably rolls actively driven on the web of material and, with a knife, produces a weakening and/or perforation on a weakened line.

In an advantageous embodiment, the pressure elements are adapted to produce a weakened line in each of the running-out and new webs of material.

The weakened line can be produced by the pressure elements, in particular by an embossing or when producing an embossed joint, for example at the transition from an embossed to an unembossed section. Furthermore, a knife or an edge can be provided on the pressure elements, which produces a weakening of the material in the respective web of material at a weakened line. In this possible embodiment, for example, a further weakening device can be omitted.

It is further proposed that the device is adapted to produce a weakened line in the new web of material downstream the conveying direction in relation to the joint, for example the embossed joint and/or adhesive joint, and/or to produce a weakened line in the running-out web of material upstream the conveying direction in relation to the embossed joint or adhesive joint.

According to an advantageous further development, it is proposed that a pivoting element is provided which is adapted to pick up the new web of material from a new bobbin, to guide it through the joining section and to transfer it to a leader winder.

This makes it possible to achieve a fully automatic process for joining two webs of material. Furthermore, the new web of material can be accelerated to process speed by means of the leader winder, so that the two webs of material can be joined dynamically at synchronized process speed.

In a further development, it is proposed that the device comprises a feeding device having two bobbin holders for bobbins of the webs of material.

The bobbin holders for the bobbins of the running-out web of material and the new web of material are preferably actively driven. The webs of material are conveyed from the feeding device through the joining section.

In a preferred embodiment, the feeding device comprises a turntable on which the bobbin holders are arranged.

The turntable allows the new bobbin holder with the bobbin of the new web of material to turn to the position of the bobbin of the running-out web of material after the webs of material have been joined.

Furthermore, a method for joining webs of material for the energy cell manufacturing industry with a device according to any one of claims 1 to 13 is proposed to solve the object.

According to a further development, it is proposed that the device comprises a leader winder having a diameter, wherein a portion of the new web of material is wound from a bobbin on a bobbin holder onto the leader winder, wherein the revolutions of the leader winder and the bobbin holder are detected, and the diameter and/or the circumference of the bobbin is calculated from the detected revolutions and from the diameter of the leader winder.

The proposed diameter calculation can be advantageously used to adjust the conveying speed and/or the point in time for the next bobbin change or for the joining with the next web of material.

The invention is explained below with reference to preferred embodiments with reference to the accompanying figures. Therein shows

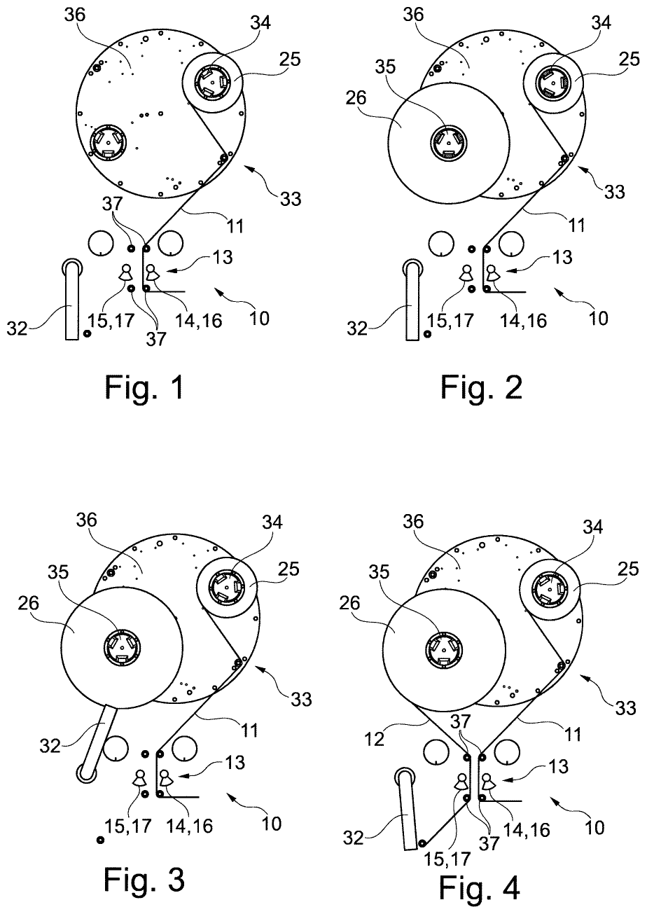

FIG. 1 a device for joining webs of material with a running-out web of material;

FIG. 2 a device for joining webs of material with a new web of material on a bobbin;

FIG. 3 a device for joining webs of material when opening the new bobbin;

FIG. 4 a device for joining webs of material with a new web of material that has been fed in;

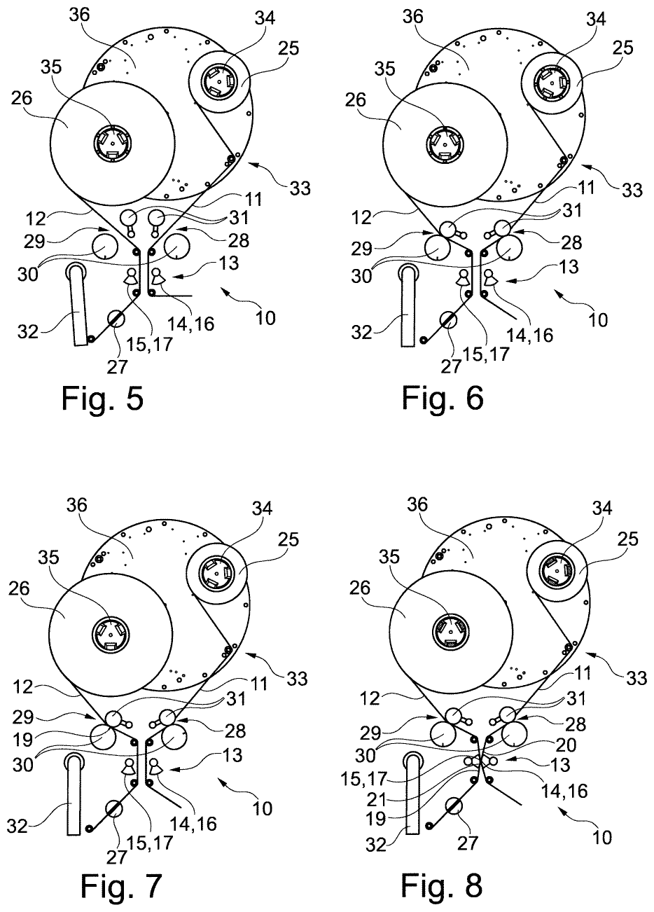

FIG. 5 a device for joining webs of material to the new web of material on a leader winder;

FIG. 6 a device for joining webs of material with pivoted counter rollers;

FIG. 7 a device for joining webs of material when producing weakened lines in the webs of material;

FIG. 8 a device for joining webs of material to pressure elements when producing an embossed joint;

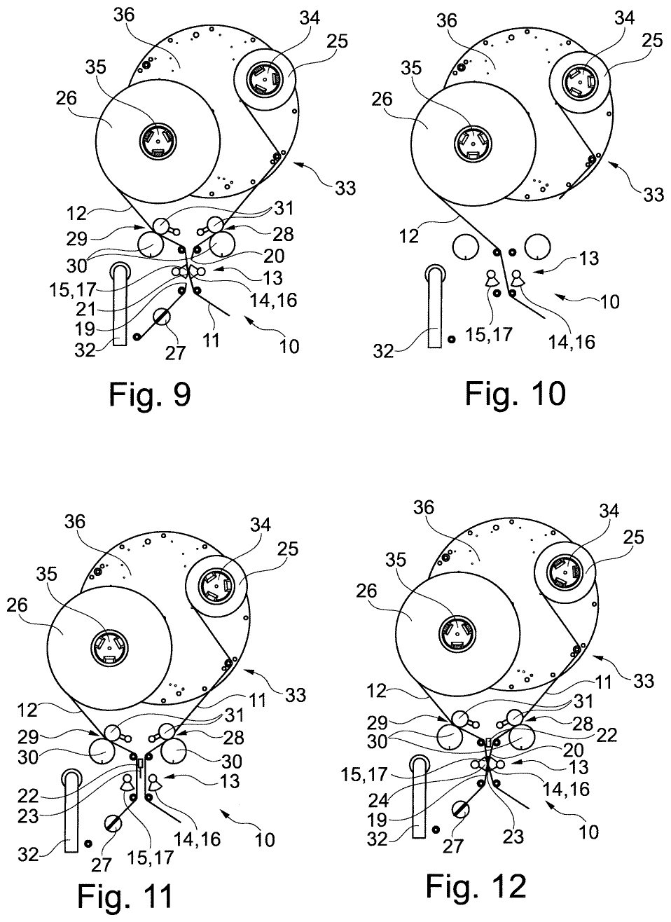

FIG. 9 a device for joining webs of material with pressure elements when separating the webs of material;

FIG. 10 a device for joining webs of material with a web of material joined by an embossed joint;

FIG. 11 a further device for joining webs of material with an adhesive sheet holder;

FIG. 12 a device for joining webs of material with pressure elements when producing an adhesive joint;

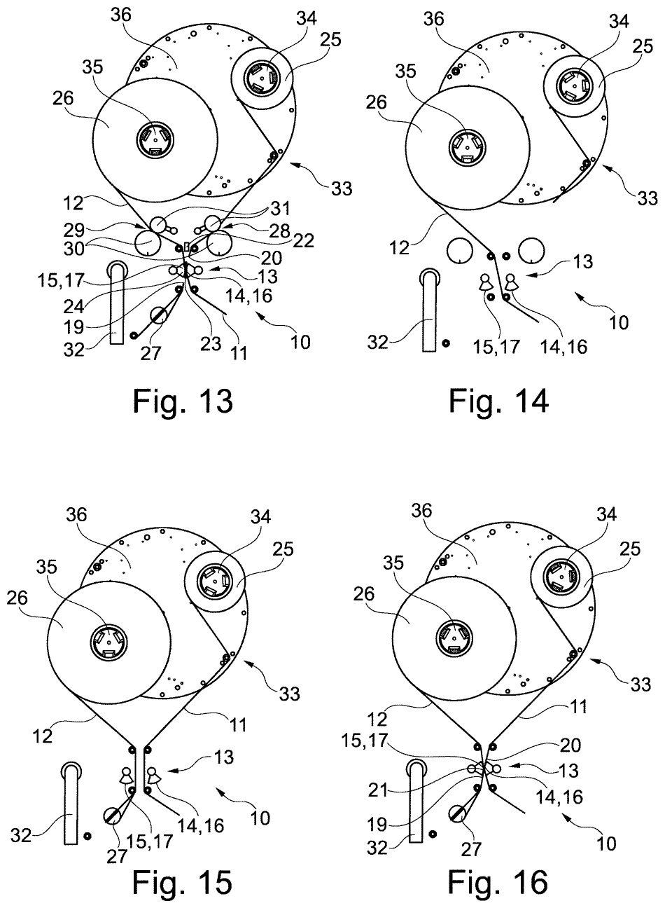

FIG. 13 a device for joining webs of material with an adhesive joint when separating the webs of material;

FIG. 14 a device for joining webs of material with a web of material joined by an adhesive joint;

FIG. 15 another embodiment of a device for joining webs of material without knife rollers;

FIG. 16 a device for joining webs of material when producing an embossed joint and a weakened line;

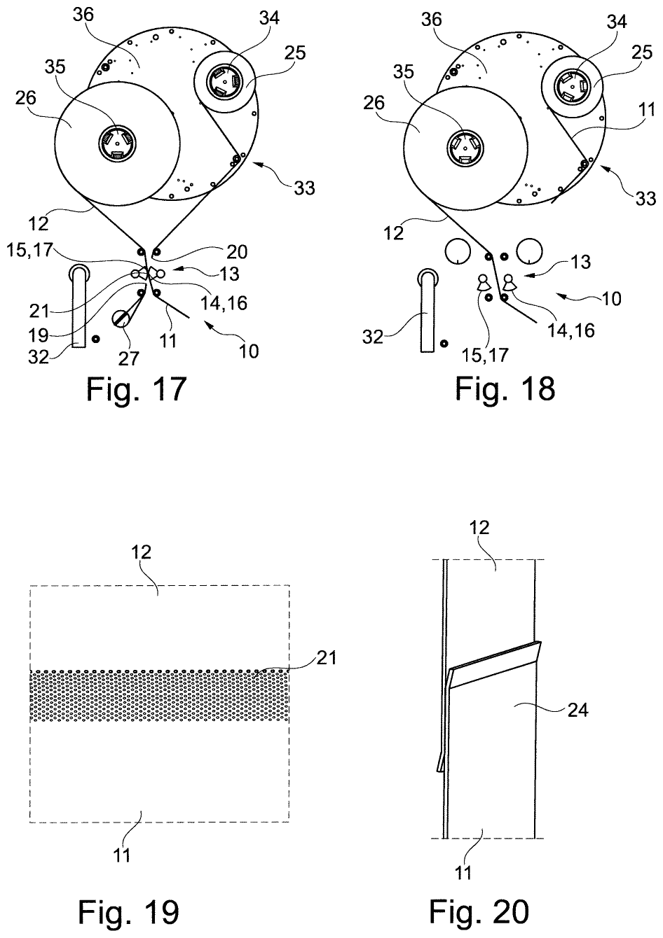

FIG. 17 a device for joining webs of material when separating the webs of material;

FIG. 18 a device for joining webs of material without knife rollers with a joined web of material;

FIG. 19 a web of material joined by an embossed joint; and

FIG. 20 a web of material joined by an adhesive joint.

FIG. 1 schematically shows an advantageous embodiment of a device 10 for joining a running-out web of material 11 to a new web of material 12, which, for example, are separator webs for the production of battery cells. The running-out web of material 11 runs off from a bobbin 25 on a bobbin holder 34. The running-out web of material 11 is guided on two rollers 37 through a joining section 13 and a subsequent process is supplied with the running-out web of material 11 at process speed.

For an endless conveying of a web of material 11, 12 to subsequent processes for the production of an energy cell, in particular a battery cell, the running-out web of material 11 is joined to a new web of material 12 with a dynamic splice in the device 10.

FIG. 2 shows the device 10 with a new bobbin 26 with the new web of material 12, which is arranged on a bobbin holder 35. In this advantageous embodiment, both bobbins 25, 26 are arranged by means of the bobbin holders 34, 35 on a turntable 36, thereby forming a feeding device 33.

FIG. 3 shows a further step in the preparation for joining the running-out web of material 11 to the new web of material 12, in which a pivoting element 32 comprises a bobbin opener, with which the bobbin 26 is opened and the beginning of the web of material 12 is picked up. The new web of material 12 is then threaded through the joining section 13, in which the new web of material 12 is guided over two rollers 37 parallel to the running-out web of material 11, as shown in FIG. 4. The new web of material 12 and the running-out web of material 11 are therefore guided one above the other with their base surfaces aligned with each other in the joining section 13. In this state, the webs of material 11, 12 comprise a distance from one another, which is defined by the guide with the rollers 37. During this time, the running-out web of material 11 can be conveyed at the process speed, whereas the new web of material 12 is stationary or is moved at a comparatively low speed for threading into the joining section 13.

In FIG. 5, the pivoting element 32 has transferred the new web of material 12 to a leader winder 27. The leader winder 27 turns until the new web of material 12 is securely wrapped around the leader winder 27. Any packaging material and the leader of the new web of material 12 can accordingly be wound up by the leader winder 27. The preparations for the actual splicing process are now complete.

In this advantageous embodiment, the device 10 comprises two weakening devices 28, 29, which each produce a weakened line 19, 20 or also a predetermined breaking line or point in the webs of material 11, 12. For this purpose, the weakening device 28, 29 comprises two pivotable counter rollers 31, which are pivoted to the contact with the one web of material 11, 12, as can be seen in FIG. 6. As a result, the webs of material 11, 12 are each displaced in such a way that they come to contact a respective knife roller 30. The weakening devices 28, 29 can, for example, be moved out of the rear wall of the device 10.

FIGS. 7 to 10 show the splicing process with the device 10 in a preferred embodiment. The leader winder 27 accelerates the new web of material 12. The weakening device 28 uses the knife roller 30 to produce a perforation at a weakened line 19, as shown in FIG. 7. FIG. 8 shows a slightly later point in time, at which the weakened line 19 has already been conveyed past the pressure elements 15, 17 in the joining section 13. The leader unit 27 preferably accelerates the speed to slightly more than the process speed in order to enable the separation at the weakened line 19 by means of an increased tensile stress in the new web of material 12.

In the illustration in FIG. 8, the further weakening device 29 for the running-out web of material 11 has also produced a weakened line 20 by means of the knife roller 30, which has already been conveyed at the processing speed into the joining section 13 between the rollers 37.

The pressure elements 15, 17 rotate and accelerate to a speed matched to the process speed and press the two webs of material 11, 12 against each other in the joining section 13. In this advantageous embodiment, the pressure surfaces of the pressure elements 15, 17, which are in contact with the webs of material 11, 12, comprise embossing surfaces which, at the point in time shown in FIG. 8, produce an embossed joint 21 between the two webs of material 11, 12 that are pressed against each other, see also FIG. 19.

At this moment, the leader winder 27 is running at a higher speed than the process speed, thereby increasing the tensile stress in the new web of material 11 between the leader winder 27 and the embossed joint 21, which is fixed between the pressure elements 15, 17 at the process speed at this moment. This leads to the separation of the new web of material 12 at the weakened line 19 prepared for this purpose. The leader of the new web of material 12 is thus separated in front of the connection point to the running-out web of material 11.

The bobbin 25 of the running-out web of material 11 on the bobbin holder 34 is braked at this point in time, so that the running-out web of material 11 is conveyed at less than the process speed. As a result, the tensile stress in the running-out web of material 11 between the bobbin 25 and the embossed joint 21, which is fixed at the process speed between the pressure elements 15, 17 at this point in time, is increased to such an extent that the running-out web of material 11 tears at the weakened line 20. The rest of the running-out web of material 11 can then be wound up. This state of the device 10 for joining webs of material 11, 12 is shown in FIG. 9.

FIG. 10 shows how the web of material 11, 12 joined by the embossed joint 21 is fed from the new bobbin 26 on the bobbin holder 35. The running-out bobbin 25 with the rest of the web of material 11 can be removed and the new bobbin 26 with the new web of material 12 can then be rotated by means of the turntable 36, on which the bobbin holders 34, 35 are arranged, to the position of the running-out bobbin 25. The new bobbin 26 with the new web of material 12 can thus take the position of the running-out bobbin 25 with the running-out web 11 after the connection. In this way, it is possible to provide an endless web of material 11, 12, in particular a separator web, for the production of battery cells using the device 10 without interrupting the conveying and, furthermore, preferably without the use of a process buffer for the web of material 11, 12.

FIGS. 11 to 14 show a further advantageous embodiment, which follows on from the preparation steps illustrated in FIGS. 1 to 6.

As shown in FIG. 11, the device 10 comprises an adhesive sheet holder 22 that is adapted to place a double-sided adhesive sheet 23 in the joining section 13. The adhesive sheet holder 22 is arranged in the joining section 13 between the rollers 37 on which the webs of material 11, 12 are guided at a distance from each other.

In the illustration in FIG. 12, the leader winder 27 accelerates the new web of material 12. The weakening device 28 uses the knife roller 30 to produce a perforation on a weakened line 19, which, when the webs of material 11, 12 are pressed against each other, has already moved past the pressure elements 15, 17 in the joining section 13.

The weakened line 20, which was produced by the weakening device 29 with the knife roller 30 and the counter roller 31 in the running-out web of material 11, is located in the illustration of FIG. 12 between the joining section 13 and the weakening device 28.

The pressure elements 15, 17 rotate and accelerate to a speed matched to the process speed and press the two webs of material 11, 12 against each other in the joining section 13, wherein the webs of material 11, 12 are displaced relative to one another so that the adhesive sheet 23 is pressed between the webs of material 11, 12 that are pressed against one another, and the webs of material 11, 12 are joined by an adhesive joint 24 via the adhesive sheet 23.

FIG. 13 illustrates a state of the device 10 in which an increased speed compared to the processing speed of the leader winder 27 increases the tensile stress in the new web of material 11 between the leader winder 27 and the adhesive joint 24 fixed at the processing speed between the pressure elements 15, 17 at this point in time. The increased tensile stress in the new web of material 12 leads to a separation at the weakened line 19.

The bobbin 25 with the running-out web of material 11 is braked to a speed below the process speed, which leads to an increase in the tensile stress in the running-out web of material 11 between the bobbin 25 and the adhesive joint 24, which is fixed at process speed at this point in time between the pressure elements 15, 17. The running-out web of material 11 is accordingly separated at the weakened line 20.

FIG. 14 shows the conveying of the web of material 11, 12 connected by the adhesive bond 24 from the new bobbin 26 on the bobbin holder 35. The new bobbin 26 with the new web of material 12 can then be turned with the turntable 36 to the position of the running out bobbin 25. The new bobbin 26 with the new web of material 12 can thus take the position of the running out bobbin 25 with the running out web 11 after the connection. This advantageous embodiment of the device 10 makes it possible to provide an endless web of material 11, 12, in particular a separator web, for the production of battery cells without interrupting the conveying and, further preferably, without the use of a process buffer for the web of material 11, 12.

FIGS. 15 to 18 show a further advantageous embodiment of a device 10 for joining webs of material 11, 12, which, in contrast to the previous embodiments, operates without weakening devices 28, 29.

FIG. 15 shows the device 10 for joining the webs of material 11, 12, in which the new web of material 12 has already been transferred to the leader winder 27. The running-out and the new web of material 11, 12 are accordingly guided in the guide section 13 lying one above the other and at a distance from each other.

In FIG. 16, the pressure elements 15, 17 arranged on both sides of the webs of material 11, 12 rotate, as in the previous embodiments, so that they come into contact with the respective web of material 11, 12. The pressure elements 15, 17 rotate at a speed matched to the process speed and press the two webs of material 11, 12 against each other in the joining section 13. The pressure surfaces of the pressure elements 15, 17, which are in contact with the webs of material 11, 12, comprise embossing surfaces in this advantageous embodiment, whereby an embossed joint 21 is produced.

The embossing process introduces weakened lines 19, 20 into the webs of material 11, 12. The weakened lines 19, 20 are preferably located at the transition of the embossed joint to the unaffected section of the webs of material 11, 12.

FIG. 17 illustrates the separation of the webs of material 11, 12 during the connection by the pressure elements 15, 17, which fix the conveyed webs of material 11, 12 at that moment. During the splicing process, the leader winder 27 is operated at a higher speed than the process speed, thereby increasing the tensile stress in the new web of material 11 between the leader winder 27 and the embossed joint 21, which is fixed at the process speed between the pressure elements 15, 17 at this point in time. This results in the new web of material 12 being severed at the weakened line 19.

The bobbin 25 of the running-out web of material 11 on the bobbin holder 34 is braked at this point so that the running-out web of material 11 is conveyed at a speed below the process speed. As a result, the tensile stress in the running-out web of material 11 between the bobbin 25 and the embossed joint 21, which is fixed at the process speed between the pressure elements 15, 17 at this point in time, is increased to such an extent that the running-out web of material 11 tears at the weakened line 20. The rest of the running-out web of material 11 can then be wound up.

The web of material 11, 12 joined by the embossed joint 21 is then fed from the new bobbin 26 on the bobbin holder 35, as shown in FIG. 18.

The new bobbin 26 with the new web of material 12 can then be turned by the turntable 36 to the position of the running-out bobbin 25. The new bobbin 26 with the new web of material 12 can thus take the position of the running-out bobbin 25 with the running-out web 11 after the connection.

FIG. 19 shows a top view of an embossed joint 21 joining a running-out web of material 11 to a new web of material 12.

FIG. 20 shows an adhesive joint 24 joining a running-out web of material 11 to a new web of material 12.

### LIST OF REFERENCE SIGNS

10 device
11 running-out web of material
12 new web of material
13 joining section
14 pressure element
15 pressure element
16 pressure surface
17 pressure surface
18 conveying direction
19 weakened line
20 weakened line
21 embossed joint
22 adhesive sheet holder
23 adhesive sheet
24 adhesive joint
25 bobbin
26 bobbin
27 leader winder
28 weakening device
29 weakening device
30 knife roller
31 counter roller
32 pivoting element
33 feeding device
34 bobbin holder
35 bobbin holder
36 turntable
37 roller

1. A device for joining webs of material-, for the production of energy cells, wherein a running-out web of material can be joined to a new web of material, wherein
the running-out web of material and the new web of material are guidable at a distance from each other in a joining section, wherein
two pivotable or rotatable pressure elements with pressure surfaces are provided, which are adapted to press the running-out and the new web of material against each other in the joining section and to join the running-out web of material and the new web of material to each other, wherein
the pressure elements are adapted to join the webs of material during the movement in the conveying direction of the running-out and new web of material, and wherein
the device is adapted to produce a weakened line, preferably a perforation line, in the running-out and in the new web of material and to separate the webs of material in each case by applying an increased tensile stress in the webs of material at the weakened lines, preferably the perforation lines.

2. The device according to claim 1, wherein
the pressure surfaces of the pressure elements are embossing surfaces, and the pressure elements are adapted to produce an embossed joint when the running-out and the new web of material are pressed against each other.

3. The device according to claim 1, wherein
the device comprises an adhesive sheet holder that is adapted to hold a double-sided adhesive sheet between the running-out and the new web of material, wherein
the pressure elements are adapted to produce an adhesive joint together with the adhesive sheet when the running-out and new webs of material are pressed against each other.

4. The device according to claim 1, wherein
the device is adapted to increase the tensile stress in the new web of material and/or in the running-out web of material during the production of the embossed joint and/or the adhesive joint, in order to separate the web of material by means of the increased tensile stress in each case.

5. The device according to claim 4, wherein the device is adapted to
build up increased tensile stress in the running-out web of material between the weakened line and a bobbin with the running-out web of material to separate the running-out web of material, and
build up increased tensile stress in the new web of material between the weakened line and a leader winder with the new web of material to separate the new web of material.

6. The device according to claim 1, wherein
the pressure elements each comprise a curved pressure surface or embossing surface which runs on a web of material during pressing on or embossing.

7. The device according to claim 1, wherein at least one weakening device is provided upstream a conveying direction in front of the joining section for the running-out web of material and/or the new web of material, which device is adapted to produce a weakened line in a web of material.

8. The device according to claim 7, wherein
the weakening device comprises a knife roller and a counter roller, wherein the counter roller is pivotable and adapted to come into contact with a web of material when pivoted, to displace the web of material and to press it against a knife roller.

9. The device according to claim 1, wherein the pressure elements are adapted to produce a weakened line in each of the running-out and the new web of material.

10. The device according to claim 1, wherein the device is adapted to produce a weakened line in the new web of material downstream the conveying direction in relation to the connection, and/or to produce a weakening line in the running-out web of material upstream the conveying direction in relation to the embossed joint or adhesive joint.

11. The device according to claim 1, wherein a pivoting element is provided which is adapted to pick up the new web of material from a new bobbin, to guide it through the joining section and to transfer it to a leader winder.

12. The device according to claim 1, wherein
the device comprises a feeding device which comprises two bobbin holders for bobbins of the webs of material.

13. The device according to claim 1, wherein
the feeding device comprises a turntable on which the bobbin holders are arranged.

14. A method for joining webs of material for the energy cell producing industry, wherein
the method is carried out using the device according to claim 1.

15. The method according to claim 14, wherein the device comprises a leader winder having a diameter, wherein a portion of the new web of material is wound from a bobbin on a bobbin receiver onto the leader winder, wherein the revolutions of the leader winder and the bobbin holder are detected, and the diameter and/or the circumference of the bobbin is calculated from the detected revolutions.
